(19) United States
(12) Patent Application Publication
(10) Pub. No.: US 2021/0221645 A1
(43) Pub. Date: Jul. 22, 2021

(54) MONITORING DEVICE FOR ELEVATOR COMPENSATION ROPING

(71) Applicant: OTIS ELEVATOR COMPANY, Farmington, CT (US)

(72) Inventor: YiSug KWON, Farmington, CT (US)

(21) Appl. No.: 16/747,803

(22) Filed: Jan. 21, 2020

(51) Int. Cl. B66B 7/12; B66B 1/28; B66B 9/00; B66B 1/34; B66B 5/02

(52) U.S. Cl. CPC B66B 7/1215; B66B 1/28; B66B 7/1238; B66B 1/3492; B66B 5/02; B66B 9/00

(57) ABSTRACT

An illustrative example embodiment of monitoring device includes a rigid central portion made of a first material and a resilient outer portion made of a second material. The central portion defines a traction surface that is configured to receive an elevator tension member. The outer portion defines an engagement surface that is configured to secure the sheave liner to an elevator sheave.

### BACKGROUND

Elevator systems are useful for carrying passengers and items between different levels of a building. Many elevator systems are traction-based and include traction roping that suspends the elevator car and a counterweight. A machine causes movement of a traction sheave that, in turn, causes movement of the traction roping for moving the elevator car as desired. One feature of traction-based elevator systems is a compensation assembly including compensation roping suspended beneath the car and counterweight and a tie down mechanism near the bottom of the hoistway. The compensation assembly facilitates maintaining appropriate tension on the roping to achieve desired traction.

Some elevator systems are susceptible to rope sway. For example, in high rise buildings that may experience building sway the traction roping and compensation roping may sway from side to side. Under certain conditions such sway may result in at least one of the compensation ropes becoming misaligned with the rest of the compensation assembly. In particular, tie down sheaves typically include grooves that receive compensation ropes and it is possible that one of the compensation ropes leaves its groove. A misaligned compensation rope can become entangled with other compensation ropes during elevator car movement, which requires service by maintenance personnel.

### SUMMARY

An illustrative example embodiment of a monitoring device for an elevator compensation assembly includes at least one detector that is configured to detect whether compensation roping moves out of a predetermined position. A controller is configured to limit elevator movement based on an indication from the detector that the compensation roping moved out of the predetermined position.

In an example embodiment having at least one of the features of the monitoring device of the previous paragraph, the at least one detector comprises a light source and a light sensor situated to sense light from the light source, the light sensor senses the light when the compensation roping is in predetermined position, and the compensation roping interrupts the light from reaching the light sensor when the compensation roping moves out of the predetermined position.

In an example embodiment having at least one of the features of the monitoring device of any of the previous paragraphs, the at least one detector comprises a contact switch that is configured to be contacted by the compensation roping when the compensation roping moves out of the predetermined position.

In an example embodiment having at least one of the features of the monitoring device of any of the previous paragraphs, the controller is configured to issue a signal or a command to stop an associated elevator when the compensation roping is outside of the predetermined position.

An illustrative example embodiment of an elevator compensation assembly includes the monitoring device of any of the previous paragraphs, a plurality of compensation roping members, and a tie-down mechanism including at least one sheave. The predetermined position includes a position of each of the compensation roping members relative to the at least one sheave and the at least one detector is configured to detect when any of the plurality of compensation roping members moves out of the predetermined position relative to the at least one sheave.

In an example embodiment having at least one of the features of the monitoring device of any of the previous paragraphs, the at least one sheave includes a plurality of grooves, a portion of each of the compensation roping members is received in a corresponding one of the grooves when the compensation roping members are in the predetermined position, and the at least one detector detects when any of the compensation roping members is outside of the corresponding one of the grooves.

An illustrative example embodiment of an elevator system includes the compensation assembly of any of the previous paragraphs, an elevator car, a counterweight, traction roping suspending the elevator car and counterweight, and a machine including a traction sheave that selectively causes movement of the traction roping to control movement of the elevator car. The compensation roping members are suspended beneath the elevator car and the counterweight.

An example embodiment having at least one of the features of the elevator system of the previous paragraph includes an elevator drive that is configured to control operation of the machine and wherein the controller is configured to provide an indication to the elevator drive to limit movement of the elevator car when the compensation roping is outside of the predetermined position.

In an example embodiment having at least one of the features of the monitoring device of any of the previous paragraphs, the controller is configured to control operation of the machine.

An illustrative example embodiment of a method of monitoring an elevator compensation assembly includes detecting whether compensation roping is in a predetermined position and limiting elevator movement based on determining that the compensation roping moved out of the predetermined position.

In an example embodiment having at least one of the features of the method of the previous paragraph, the detecting comprises situating at least one detector that comprises a light source and a light sensor near the predetermined position, emitting light from the light source toward the light sensor, and detecting when the compensation roping moves out of the predetermined position and interrupts the light from reaching the light sensor.

An example embodiment having at least one of the features of the method of any of the previous paragraphs includes situating at least one contact switch near the predetermined position such that the at least one contact switch is configured to be contacted by the compensation roping when the compensation roping moves out of the predetermined position.

In an example embodiment having at least one of the features of the method of any of the previous paragraphs, the limiting elevator movement comprises stopping elevator movement.

In an example embodiment having at least one of the features of the method of any of the previous paragraphs, the elevator compensation assembly includes a plurality of compensation roping members and a tie-down mechanism including at least one sheave, the predetermined position includes a position of each of the compensation roping members relative to the at least one sheave, and the detecting comprises detecting when any of the plurality of compensation roping members moves out of the predetermined position relative to the at least one sheave.

In an example embodiment having at least one of the features of the method of any of the previous paragraphs, the at least one sheave includes a plurality of grooves, a portion of each of the compensation roping members is received in a corresponding one of the grooves when the compensation roping members are in the predetermined position, and the detecting comprises detecting when any of the compensation roping members is outside of the corresponding one of the grooves.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 schematically illustrates selected portions of an example elevator compensation assembly.

FIG. 3 schematically illustrates an example condition of the elevator compensation assembly.

### DETAILED DESCRIPTION

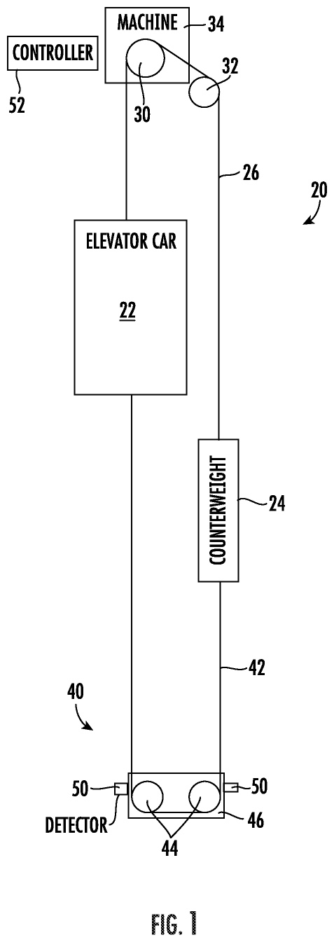

FIG. 1 schematically illustrates selected portions of an elevator system 20. An elevator car 22 is coupled to a counterweight 24 by traction roping 26. Although not shown in detail, the traction roping 26 includes a plurality of tension members, such as round ropes or flat belts. The traction roping 26 follows a path defined, at least in part, by sheaves 30 and 32. The sheave 30 is a traction sheave associated with a machine 34 that selectively causes movement of the traction roping 26 to control the movement and position of the elevator car 22 for providing elevator service to passengers.

The elevator system 20 includes a compensation assembly 40 that facilitates maintaining adequate tension on the traction roping 26 to achieve desired traction under a variety of elevator system conditions. The compensation assembly 40 includes compensation roping 42 that is suspended beneath the elevator car 22 and counterweight 24. The compensation roping 42 follows a path defined, at least in part, by compensation sheaves 44, which are supported as part of a tie down mechanism 46.

At least one detector 50 is situated to detect when the compensation roping 42 moves out of a predetermined position. In the illustrated example, at least one detector 50 is associated with each of the compensation sheaves 44. A controller 52 receives an indication from the detectors 50 whenever the compensation roping 42 moves out of the predetermined position. The controller 52 is configured to limit movement of the elevator car 22 in response to an indication from a detector 50 that the compensation roping 42 has moved out of the predetermined position. In some embodiments, the controller 52 is configured to immediately stop movement of the elevator car 22. In other embodiments, the controller 52 is configured to limit elevator car movement by reducing a speed of the elevator car 22 and parking the elevator car 22 at a nearby landing.

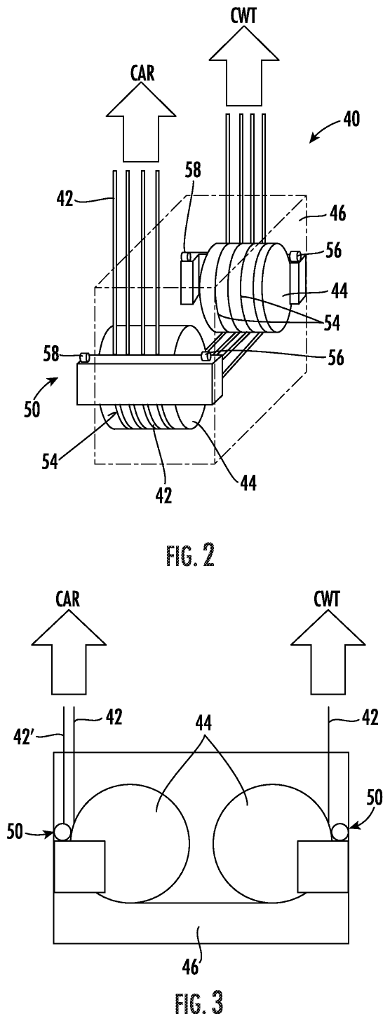

FIGS. 2 and 3 schematically illustrate selected portions of the compensation assembly 40. In this example, the compensation roping 42 includes a plurality of compensation roping members, which are individual ropes or belts, for example. Each of the compensation roping members 42 is received within a corresponding groove 54 on each of the compensation sheaves 44. The predetermined position of the compensation roping 42 in this example embodiment includes the portion of the compensation roping 42 wrapped about each compensation sheave 44 being properly received within the corresponding one of the grooves 54.

The detectors 50 are situated to detect whenever any of the compensation roping members 42 moves out of the corresponding groove 54 on a compensation sheave 44. In the example of FIG. 2, the detector 50 includes a light source 56 and a light sensor 58. The light source 56 emits a beam of light toward the light sensor 58. When the compensation roping members 42 are properly received within the corresponding grooves 54, the light sensor 58 is able to receive and sense the light beam from the light source 56. Whenever any of the compensation roping members 42 moves away from or out of the corresponding groove 54, such a compensation roping member 42 interrupts the light beam and the light sensor 58 provides an indication that at least one of the compensation roping members 42 has moved out of the predetermined position and is no longer properly received within the corresponding grove 54.

Such movement of at least one of the compensation roping members 42 is schematically represented at 42′ in FIG. 3. On the right side (according to the drawing), all compensation roping members 42 are properly received in the corresponding grooves 54. On the left side (according to the drawing), however, at least one of the compensation roping members 42 has moved out of its corresponding groove 54 and is situated where it at least partially obstructs the light beam from the light source 56 and the light sensor 58 provides an indication of that condition.

In another example embodiment, the detector 50 comprises at least one contact switch that is supported on the tie down mechanism 46 in a position relative to the compensation sheave 44 where a compensation roping member 42 that moves out of its corresponding groove 54 will make contact with the contact switch resulting in an indication being provided to the controller 52 to limit movement of the elevator car 22.

The controller 52 in some embodiments is a dedicated computing device including a processor that is configured to process signals from the detectors 50. In other embodiments, the controller 52 is realized through a portion of an elevator controller that includes a drive for controlling the machine 34.

The manner in which indications are provided by the detectors 50 to the controller 52 may vary depending on the configuration of the elevator system 20. For example, an existing elevator CAN bus communication line is used in some embodiments for communications between the detectors 50 and the controller 52. Other embodiments include wireless communication between the detectors 50 and the controller 52.

The controller 52 is configured to limit or prevent movement of the elevator car based on an indication from at least one sensor 50 and to prevent subsequent, normal elevator car movement until authorized personnel make any necessary adjustments or repairs and provide an appropriate reset signal or command This feature protects against complications or damage that may otherwise occur if the elevator system 20 continued operating while some of the compensation roping 42 is out of the proper position, which can lead to entanglement of compensation roping members 42.

The illustrated and described example embodiments provide protection against compensation roping members become entangled with each other as a result of at least one of the compensation roping members coming out of a corresponding groove on a compensation sheave, which may be due to roping sway that causes lateral or side-to-side movement of the compensation roping. The disclosed compensation monitoring device and method reduce potential complications that may occur as a result of such compensation roping sway or other movement out of a predetermined position for the compensation roping. A technician is able to address the situation and minimize any damage to the compensation roping or other components of the elevator system 20.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A monitoring device for an elevator compensation assembly, the monitoring device comprising:
at least one detector that is configured to detect whether compensation roping moves out of a predetermined position; and
a controller that is configured to limit elevator movement based on an indication from the at least one detector that the compensation roping moved out of the predetermined position.

2. The monitoring device of claim 1, wherein
the at least one detector comprises a light source and a light sensor situated to sense light from the light source;
the light sensor senses the light when the compensation roping is in predetermined position; and
the compensation roping interrupts the light from reaching the light sensor when the compensation roping moves out of the predetermined position.

3. The monitoring device of claim 1, wherein the at least one detector comprises a contact switch that is configured to be contacted by the compensation roping when the compensation roping moves out of the predetermined position.

4. The monitoring device of claim 1, wherein the controller is configured to issue a signal or a command to stop an associated elevator when the compensation roping is outside of the predetermined position.

5. An elevator compensation assembly, comprising:
the monitoring device of claim 1;
a plurality of compensation roping members; and
a tie-down mechanism including at least one sheave;
wherein
the predetermined position includes a position of each of the compensation roping members relative to the at least one sheave, and
the at least one detector is configured to detect when any of the plurality of compensation roping members moves out of the predetermined position relative to the at least one sheave.

6. The elevator compensation assembly of claim 5, wherein
the at least one sheave includes a plurality of grooves;
a portion of each of the compensation roping members is received in a corresponding one of the grooves when the compensation roping members are in the predetermined position; and
the at least one detector detects when any of the compensation roping members is outside of the corresponding one of the grooves.

7. An elevator system, comprising:
the compensation assembly of claim 5;
an elevator car;
a counterweight;
traction roping suspending the elevator car and counterweight; and
a machine including a traction sheave that selectively causes movement of the traction roping to control movement of the elevator car,
wherein the compensation roping members are suspended beneath the elevator car and the counterweight.

8. The elevator system of claim 7, comprising an elevator drive that is configured to control operation of the machine and wherein the controller is configured to provide an indication to the elevator drive to limit movement of the elevator car when the compensation roping is outside of the predetermined position.

9. The elevator system of claim 7, wherein the controller is configured to control operation of the machine.

10. A method of monitoring an elevator compensation assembly, the method comprising:
detecting whether compensation roping is in a predetermined position; and
limiting elevator movement based on determining that the compensation roping moved out of the predetermined position.

11. The method of claim 10, wherein the detecting comprises
situating at least one detector that comprises a light source and a light sensor near the predetermined position;
emitting light from the light source toward the light sensor; and
detecting when the compensation roping moves out of the predetermined position and interrupts the light from reaching the light sensor.

12. The method of claim 10, wherein the detecting comprises
situating at least one contact switch near the predetermined position such that the at least one contact switch is configured to be contacted by the compensation roping when the compensation roping moves out of the predetermined position.

13. The method of claim 10, wherein the limiting elevator movement comprises stopping elevator movement.

14. The method of claim 10 wherein
the elevator compensation assembly includes a plurality of compensation roping members and a tie-down mechanism including at least one sheave;
the predetermined position includes a position of each of the compensation roping members relative to the at least one sheave; and
the detecting comprises detecting when any of the plurality of compensation roping members moves out of the predetermined position relative to the at least one sheave.

15. The method of claim 14, wherein
the at least one sheave includes a plurality of grooves;
a portion of each of the compensation roping members is received in a corresponding one of the grooves when the compensation roping members are in the predetermined position; and
the detecting comprises detecting when any of the compensation roping members is outside of the corresponding one of the grooves.
